(19) United States
(12) Patent Application Publication
(10) Pub. No.: US 2025/0067951 A1
(43) Pub. Date: Feb. 27, 2025

(54) LENS DEVICE

(71) Applicant: FUJIFILM Corporation, Tokyo (JP)

(72) Inventors: Nobuyuki KONDO, Saitama (JP); Kazuyoshi AZEGAMI, Saitama (JP)

(73) Assignee: FUJIFILM Corporation, Tokyo (JP)

(21) Appl. No.: 18/811,775

(22) Filed: Aug. 22, 2024

(30) Foreign Application Priority Data
Aug. 25, 2023 (JP) 2023-137206

(51) Int. Cl. G02B 7/02

(52) U.S. Cl. CPC G02B 7/021

(57) ABSTRACT

A lens device includes a first lens frame that holds a first lens and that includes a first chord portion, a second lens frame that holds a second lens and that includes a second chord portion, a first adjustment mechanism that performs first adjustment of the first lens frame, a second adjustment mechanism that performs second adjustment of the first lens frame and the second lens frame, and a stop mechanism. The first adjustment mechanism and the second adjustment mechanism are disposed at positions that are closer to an image plane side than a first position is and closer to an objective side than the stop mechanism is, the first position being a position at which a second surface and a first optical axis of the first lens intersect each other, and a position of the stop mechanism in an optical axis direction is fixed.

### CROSS-REFERENCE TO RELATED APPLICATIONS

This application claims priority under 35 U.S.C § 119 (a) to Japanese Patent Application No. 2023-137206 filed on 25 Aug. 2023. The above application is hereby expressly incorporated by reference, in its entirety, into the present application.

### BACKGROUND OF THE INVENTION

### 1. Field of the Invention

The present invention relates to a lens device.

### 2. Description of the Related Art

Described in JP6112207B (corresponding to US2016/170228A1) is an optical device (a lens device) including a first lens group having a negative refractive index and a second lens group having a positive refractive index, in which the focal length of the optical device can be changed by changing an air interval between the first lens group and the second lens group, and an adjustment mechanism that performs position adjustment in which a part or all of lens groups of the first lens group and a part of lens groups of the second lens group are shifted or tilted to be made eccentric after assembly of the first lens group and the second lens group is provided.

Described in JP2012-42663A is an imaging lens (a lens device) including a first lens group having a positive optical power and a second lens group having a positive optical power, in which the first lens group consists of a front group having a negative optical power and a rear group having a positive optical power, and an adjustment mechanism that performs position adjustment in which the front group is shifted to be made eccentric and at least one of the first lens group or the second lens group is tilted to be made eccentric after assembly of the first lens group and the second lens group is provided.

### SUMMARY OF THE INVENTION

An object of one embodiment according to the present disclosed technology is to provide a lens device, with which it is possible to easily perform optical axis adjustment and to reduce the size and weight of the entire device.

According to one aspect of the present disclosed technology, there is provided a lens device including a first lens frame, a second lens frame, a first adjustment mechanism, a second adjustment mechanism, and a stop mechanism. The first lens includes a first surface positioned on an objective side and a second surface positioned on the image plane side, the first adjustment mechanism and the second adjustment mechanism are disposed at positions that are closer to the image plane side than a first position is and closer to the objective side than the stop mechanism is, the first position being a position at which the second surface and a first optical axis of the first lens intersect each other, and a position of the stop mechanism in an optical axis direction is fixed with respect to a first lens group including the first lens and the second lens. The first lens frame holds a first lens and includes a first chord portion. The second lens frame holds a second lens positioned on an image plane side with respect to the first lens and includes a second chord portion. The first adjustment mechanism performs first adjustment of the first lens frame. The second adjustment mechanism performs second adjustment of the first lens frame and the second lens frame. The stop mechanism is positioned on the image plane side with respect to the second lens.

It is preferable that the second adjustment mechanism includes a second eccentricity pin of which a head portion is eccentric with respect to a shaft portion, the second lens frame includes an end surface portion positioned radially outward of the second lens and a polygonal press-fitting hole formed in the end surface portion, and the shaft portion of the second eccentricity pin is press-fitted into the press-fitting hole.

It is preferable that the second lens frame includes a recess portion recessed in the optical axis direction, and the press-fitting hole is connected to the recess portion.

It is preferable that, in a state where the second eccentricity pin is press-fitted into the press-fitting hole, the shaft portion is exposed at the recess portion as seen in the optical axis direction.

It is preferable that the lens device further includes a support member that supports the second lens frame, the support member includes a regulation portion that regulates a position of the head portion in the optical axis direction, and the second adjustment mechanism performs the second adjustment with the second eccentricity pin, of which the shaft portion is press-fitted into the press-fitting hole and of which the head portion is positionally regulated by the regulation portion, rotated around a central axis of the head portion so that a position of the shaft portion is displaced in the optical axis direction.

It is preferable that the second lens frame includes a plurality of the press-fitting holes, the second eccentricity pin is press-fitted into each of the plurality of press-fitting holes, and the second adjustment with respect to degrees of inclination of the first optical axis of the first lens and a second optical axis of the second lens is performed with at least one second eccentricity pin rotated around the central axis so that the position of the shaft portion of the second eccentricity pin is displaced.

It is preferable that the lens device further includes a regulation member that regulates a position of the first lens frame in the optical axis direction, the first lens frame includes a positioning portion that is disposed at the first chord portion and four projection portions that protrude in the optical axis direction and come into contact with the regulation member, the four projection portions are at positions that are line-symmetrical with respect to a symmetry axis passing through the positioning portion and the first optical axis as seen in the optical axis direction, and two of the four projection portions are disposed along the first chord portion.

It is preferable that three second adjustment mechanisms are disposed, one of the second adjustment mechanisms is at a position on the symmetry axis, and remaining two second adjustment mechanisms are at positions that are line-symmetrical with respect to the symmetry axis.

It is preferable that two first adjustment mechanisms are disposed and are at positions that are line-symmetrical with respect to the symmetry axis.

It is preferable that the first adjustment mechanism includes a first eccentricity pin of which a head portion is eccentric with respect to a shaft portion, the second lens frame includes a fitting hole to which the shaft portion of the first eccentricity pin is fitted, the first lens frame includes a pressing target portion that is pressed by the first eccentricity pin, and the first adjustment mechanism performs the first adjustment with the first eccentricity pin, which is fitted to the fitting hole, rotated around a central axis of the shaft portion so that the pressing target portion is pressed.

It is preferable that the second lens frame includes a plurality of the fitting holes, the first lens frame includes the pressing target portions corresponding to the fitting holes, the first eccentricity pin is fitted to each of the plurality of fitting holes, and the first adjustment in which the first lens frame is shifted in a direction intersecting the optical axis is performed with at least one first eccentricity pin rotated so that the pressing target portion is pressed.

It is preferable that outer peripheral surfaces of the first lens frame and the second lens frame are partially arc-shaped, and the first chord portion and the second chord portion are surfaces that intersect the arc-shaped outer peripheral surfaces.

### BRIEF DESCRIPTION OF THE DRAWINGS

FIG. 1 is a front perspective view of a digital camera.

FIG. 2 is a rear perspective view of the digital camera.

FIG. 3 is a main-part cross-sectional view of the digital camera.

FIG. 4 is a perspective view of a first lens frame, a second lens frame, and first adjustment mechanisms.

FIG. 5 is a front view of the first lens frame.

FIG. 6 is a front view of the second lens frame.

FIG. 7 is a perspective view of a first off-center eccentricity pin.

FIG. 8 is a front view of a state where first adjustment is performed with the first lens frame and the second lens frame integrated with each other.

FIG. 9A is a description view showing a state before the first adjustment and FIG. 9B is a description view showing a state during the adjustment.

FIG. 10 is a perspective view of the first lens frame, the second lens frame, and second adjustment mechanisms.

FIG. 11 is a perspective view for description of a step of press-fitting a second eccentricity pin into a press-fitting hole.

FIG. 12 is a main-part sectional view of a state where the second eccentricity pin is press-fitted into the press-fitting hole.

FIG. 13 is a side view of a state where second adjustment is performed with the first lens frame and the second lens frame integrated with each other.

FIG. 14 is a main-part cross-sectional view taken along line XIV-XIV of FIG. 13 and is a main-part cross-sectional view showing a state before the second adjustment.

FIG. 15 is a main-part cross-sectional view showing a state during the second adjustment.

FIG. 16 is a main-part cross-sectional view of a lens device, which is for description of disposition of the first adjustment mechanisms and the second adjustment mechanisms.

FIG. 17 is a main-part cross-sectional view of the digital camera, which is for description of disposition of a circuit board.

### DESCRIPTION OF THE PREFERRED EMBODIMENTS

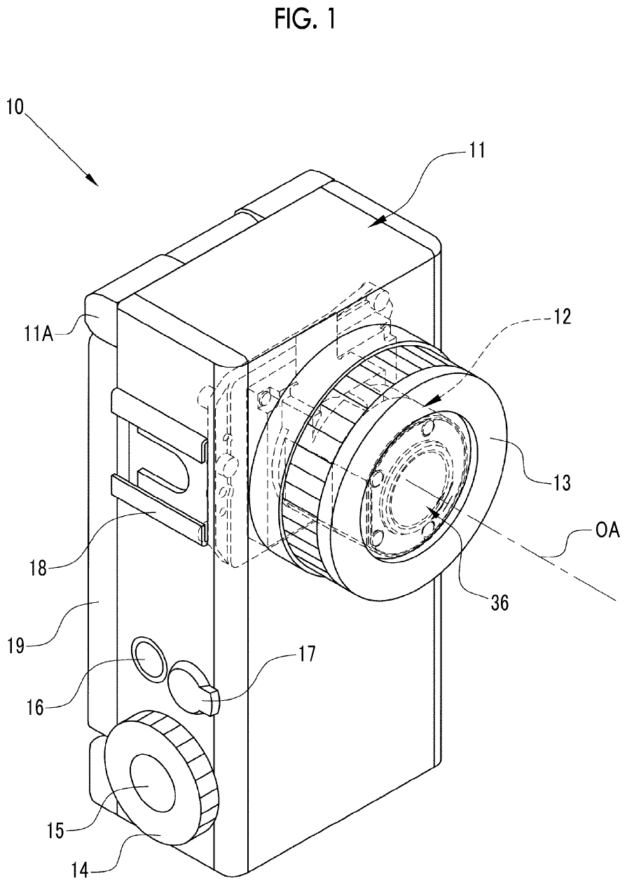

As shown in FIG. 1, a digital camera 10 includes a camera body 11 and a lens device 12. In the present embodiment, the camera body 11 has a vertically long box-like shape of which a dimension in a vertical direction is larger than a dimension in a lateral direction as seen in a front view. A front surface of the camera body 11 is provided with a lens barrel portion 13. One side surface of the camera body 11 is provided with a mode dial 14, a release switch 15, a power switch 16, an operation lever 17, a hot shoe 18, and the like. An external flash device or the like is attachably and detachably attached to the hot shoe 18. In addition, since the hot shoe 18 is provided with flash sync contacts (not shown), the attached flash device can be caused to emit light in conjunction with the releasing of a shutter.

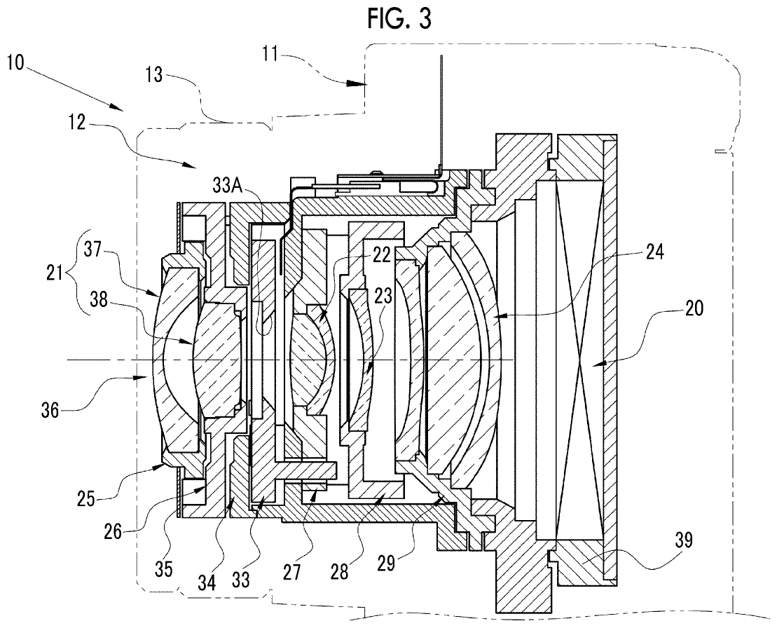

An imaging element 20 (refer to FIG. 3) is built into the camera body 11. The imaging element 20 is, for example, a complementary metal-oxide semiconductor (CMOS) image sensor, a charge-coupled device (CCD) image sensor, or an organic thin film imaging element.

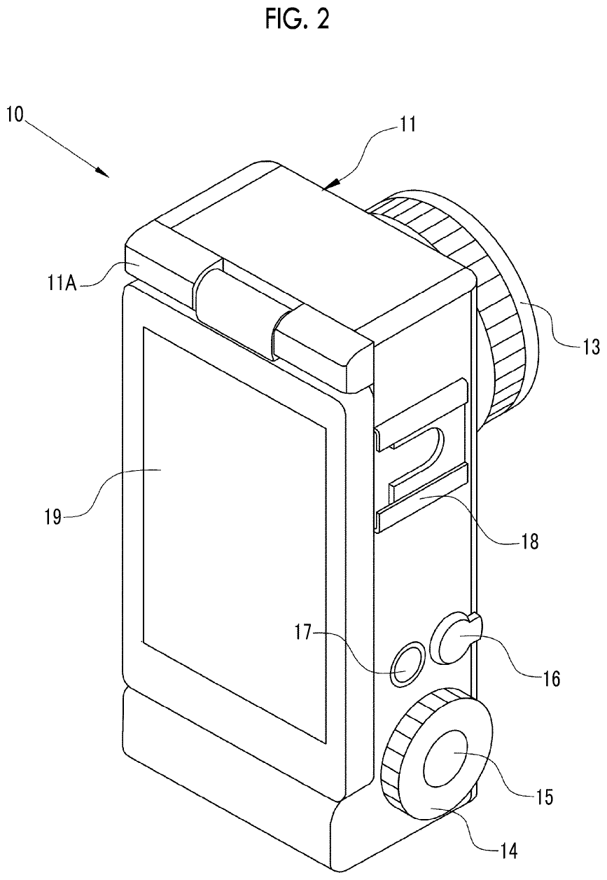

As shown in FIG. 2, a rear surface of the camera body 11 is provided with a display 19. The display 19 is a liquid crystal display (LCD), an organic electroluminescent display (OELD), or the like. The display 19 is used for live view display, the displaying of a captured image, the displaying of a setting menu, and the like. In the case of the live view display, a captured image of a subject indicated by image data acquired by the imaging element 20 is displayed on the display 19 in real time. The display 19 is attached to the camera body 11 to be rotationally movable about a hinge portion 11A.

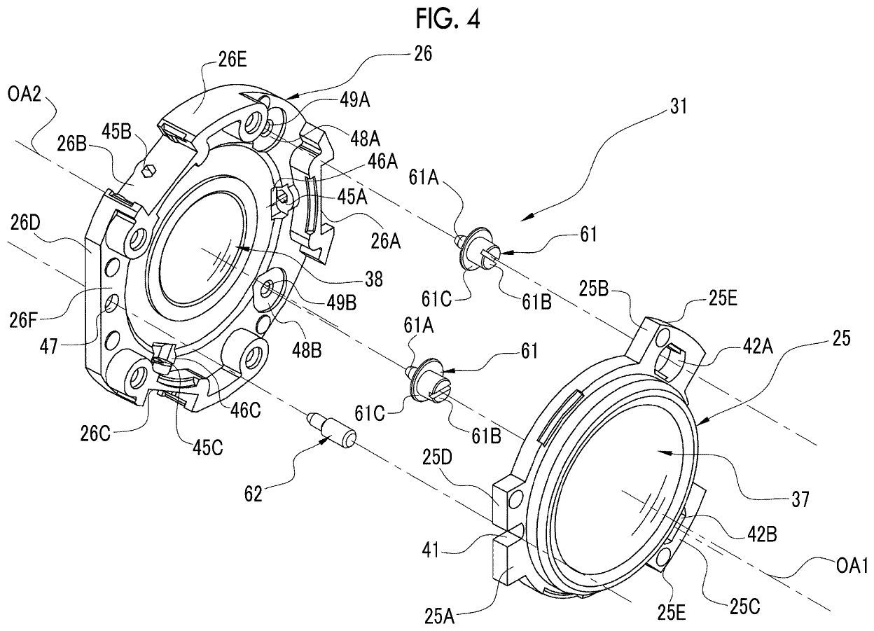

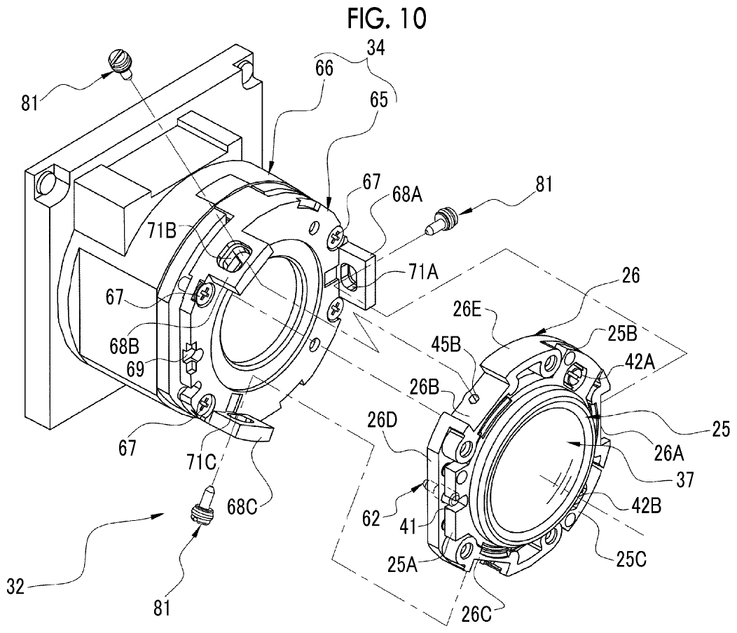

As shown in FIG. 3, the lens device 12 is positioned inside the lens barrel portion 13 and forms an image of subject light on the imaging element 20. The lens device 12 includes first to fourth lens groups 21 to 24, first to fifth lens frames 25 to 29, first adjustment mechanisms 31 (refer to FIG. 4), second adjustment mechanisms 32 (refer to FIG. 10), a stop mechanism 33, a support member 34, and a regulation member 35. Note that in each of aspects which will be described below, the first to fourth lens groups 21 to 24 may be lens groups each of which is composed of a plurality of lenses. The imaging element 20 is held by a holder 39 and is fixed to an image plane side of the lens device 12.

The first to fourth lens groups 21 to 24 constitute an imaging lens 36. The configuration of the imaging lens 36 is not limited thereto, and a configuration in which a lens group other than the first to fourth lens groups 21 to 24 is provided may also be adopted. The first lens group 21 includes a first lens 37 and a second lens 38. Note that regarding the configuration of the first lens group 21, for example, a configuration in which another lens is disposed between the first lens 37 and the second lens 38 may also be adopted as long as the first lens group 21 includes the first lens 37 and the second lens 38.

The first lens frame 25 holds the first lens 37. The second lens frame 26 holds the second lens 38. In addition, the third to fifth lens frames 27 to 29 hold the second to fourth lens groups 22 to 24, respectively. The first lens 37 is positioned closest to an objective side among the lenses of the imaging lens 36.

As shown in FIG. 4, the first lens frame 25 includes protruding portions 25A to 25C that protrude radially outward. The protruding portion 25A includes a positioning portion 41. The protruding portions 25B and 25C include pressing target portions 42A and 42B, respectively. The positioning portion 41 is a groove to which a positioning pin 62 which will be described later is fitted. The pressing target portions 42A and 42B are fitting holes to which first eccentricity pins 61, which will be described later, are fitted.

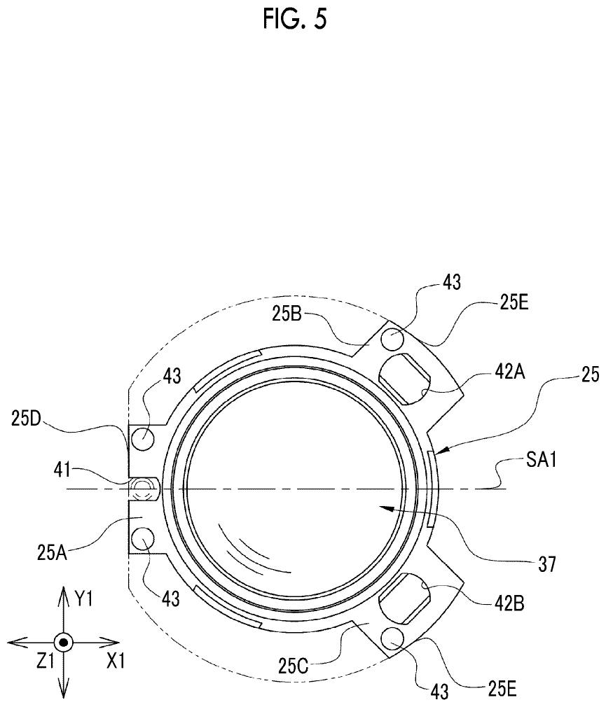

The pressing target portions 42A and 42B are at positions that are line-symmetrical with respect to a symmetry axis SA1 (refer to FIG. 5). The symmetry axis SA1 is a symmetry axis passing through the positioning portion 41 and a first optical axis OA1 (refer to FIG. 4) of the first lens 37. Hereinafter, “being orthogonal to each other” also means intersecting each other while being approximately orthogonal to each other and “being coaxial with each other” also means being at positions to be approximately coaxial with each other. Note that a Z1 direction is a direction parallel to the first optical axis OA1 of the first lens 37, an X1 direction is a direction parallel to the symmetry axis SA1 and orthogonal to the Z1 direction, and a Y1 direction is a direction orthogonal to the Z1 direction and the X1 direction.

As shown in FIG. 5, the first lens frame 25 includes a first chord portion 25D. The above-described positioning portion 41 is disposed at the first chord portion 25D. Therefore, the first chord portion 25D is disposed to intersect the symmetry axis SA1. An outer peripheral surface of the first lens frame 25 is partially arc-shaped, and the first chord portion 25D is a surface that intersects arc-shaped outer peripheral surfaces 25E. Specifically, the outer peripheral surfaces 25E of the protruding portions 25B and 25C and the first chord portion 25D of the protruding portion 25A are disposed to intersect each other. Note that intersection at the first lens frame 25 may mean actual intersection between the first chord portion 25D and the outer peripheral surfaces 25E and may also mean intersection between a plane (represented by a two-dot chain line) obtained by extending the outer peripheral surface 25E and a plane (represented by a two-dot chain line) obtained by extending the first chord portion 25D as in the present embodiment. In the present embodiment, the second lens 38 is positioned on an image plane side with respect to the first lens 37 (refer to FIG. 3).

In addition, the first lens frame 25 includes four projection portions 43 protruding in the Z1 direction. The projection portions 43 come into contact with the regulation member 35. The four projection portions 43 are at positions that are line-symmetrical with respect to the symmetry axis SA1 as seen in the Z1 direction, and two of the four projection portions 43 are disposed along the first chord portion 25D.

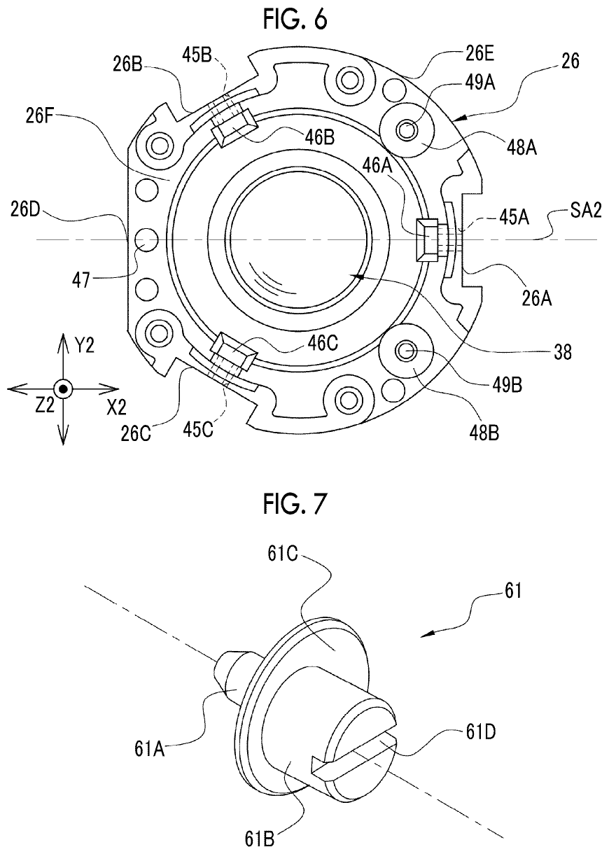

As shown in FIG. 6, regarding the outer shape of the second lens frame 26, the second lens frame 26 includes end surface portions 26A to 26C, a second chord portion 26D, and an outer peripheral surface 26E. The outer peripheral surface 26E is a portion of an outer peripheral surface of the second lens frame 26 and is formed in an arc-like shape. The end surface portions 26A to 26C are portions including terminals of the outer shape of the second lens frame 26 and the vicinities thereof. In the present embodiment, the end surface portions 26A to 26C are positioned radially outward of the second lens 38 and are positioned radially inward of the outer peripheral surface 26E.

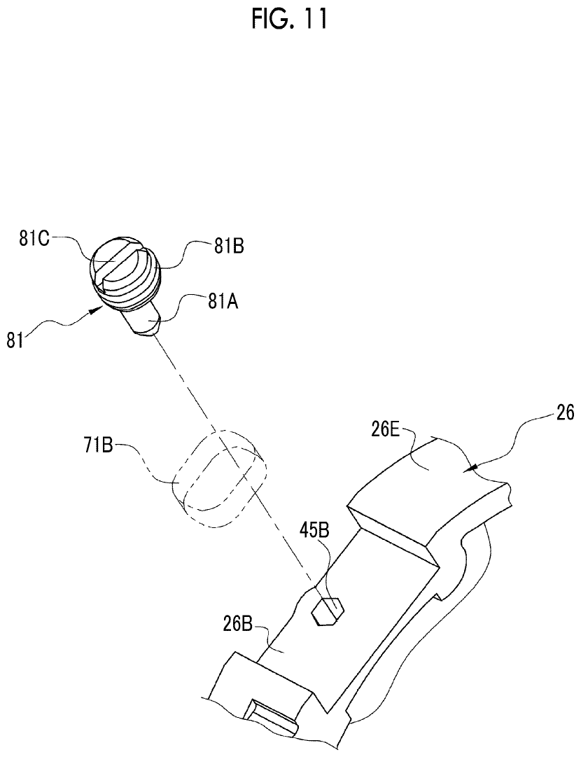

The second lens frame 26 includes a plurality of press-fitting holes. In the present embodiment, the second lens frame 26 includes three press-fitting holes 45A to 45C. Specifically, the press-fitting holes 45A to 45C are disposed in the end surface portions 26A to 26C, respectively. The press-fitting holes 45A to 45C are through-holes each having a polygonal cross-sectional shape, and second eccentricity pins 81 which will be described later are press-fitted into the press-fitting holes 45A to 45C. In the present embodiment, the press-fitting holes 45A to 45C are formed to have a hexagonal cross-sectional shape (refer to FIG. 11).

The second chord portion 26D is a surface that intersects the outer peripheral surface 26E. Note that intersection at the second lens frame 26 may mean actual intersection between the second chord portion 26D and the outer peripheral surfaces 26E and may also mean intersection between a plane obtained by extending the outer peripheral surface 26E and a plane obtained by extending the second chord portion 26D as in the present embodiment.

The second lens frame 26 includes recess portions 46A to 46C, a positioning hole 47, rotary guide portions 48A and 48B, and fitting holes 49A and 49B which are positioned radially inward of the outer peripheral surface 26E. The recess portions 46A to 46C are provided at an objective-side surface 26F of the second lens frame 26 while being at positions respectively corresponding to the end surface portions 26A to 26C, and are recessed in a Z2 direction. Note that the Z2 direction is a direction parallel to a second optical axis OA2 of the second lens 38, an X2 direction is a direction parallel to a symmetry axis SA2 which will be described later and orthogonal to the Z2 direction, and a Y2 direction is a direction orthogonal to the Z2 direction and the X2 direction. In addition, the present invention is not limited thereto and the recess portions 46A to 46C may be provided at an image-plane-side surface of the second lens frame 26. The press-fitting holes 45A to 45C are connected to the recess portions 46A to 46C. Specifically, the press-fitting holes 45A to 45C penetrate from the end surface portions 26A to 26C to the recess portions 46A to 46C.

The press-fitting holes 45B and 45C are at positions that are line-symmetrical with respect to the symmetry axis SA2, and the press-fitting hole 45A is at a position on the symmetry axis SA2. The symmetry axis SA2 is a symmetry axis extending through the positioning hole 47 and the second optical axis OA2 (refer to FIG. 4) of the second lens 38.

Shaft portions 61A of the first eccentricity pins 61 are rotatably fitted to the fitting holes 49A and 49B, respectively. The fitting holes 49A and 49B are at positions that are line-symmetrical with respect to the symmetry axis SA2. The rotary guide portions 48A and 48B are circular hole portions formed to be coaxial with the fitting holes 49A and 49B and are formed to match flange portions 61C of the first eccentricity pins 61. The rotary guide portions 48A and 48B guide rotation of the first eccentricity pins 61 fitted to the fitting holes 49A and 49B. The fitting holes 49A and 49B may be through-holes each having a polygonal cross-sectional shape as with the press-fitting holes 45A to 45C. Accordingly, it is possible to easily press-fit the first eccentricity pins 61, and it is also possible to perform a step again.

The stop mechanism 33 is positioned on the image plane side with respect to the second lens 38 (refer to FIG. 3). The position of the stop mechanism 33 is fixed in the Z1 direction and the Z2 direction with respect to the first lens group including the first lens 37 and the second lens 38. In the present embodiment, the stop mechanism 33 is fixed to the support member 34. In addition, in the present embodiment, a stop opening 33A of the stop mechanism 33 is fixed. Note that the present invention is not limited thereto, and a configuration in which the stop opening is variable by operating a stop leaf blade or the like may also be adopted.

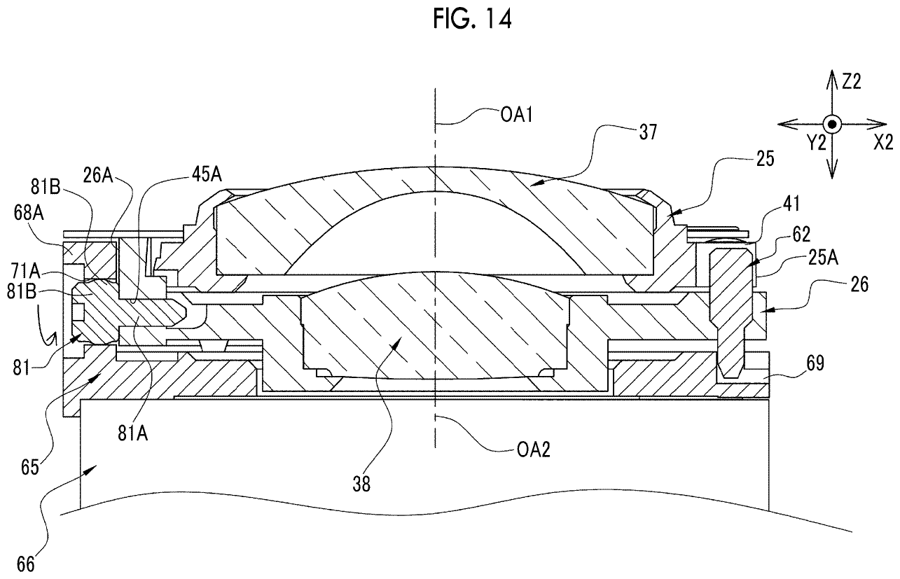

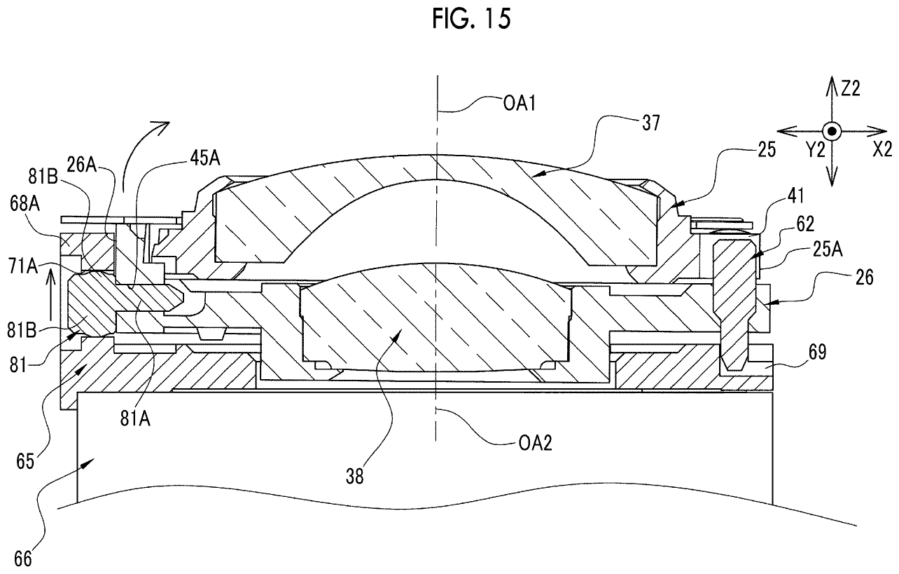

The first adjustment mechanisms 31 include the first eccentricity pins 61 and the positioning pin 62. The positioning pin 62 is fitted to the positioning hole 47 of the second lens frame 26 to be fixed to the second lens frame 26. The positioning pin 62 fixed to the second lens frame 26 protrudes to the objective side and the image plane side with respect to the second lens frame 26 (a state shown in FIGS. 14 and 15).

As shown in FIG. 7, the first eccentricity pin 61 includes the shaft portion 61A, a head portion 61B, and the flange portion 61C. The head portion 61B has an outer diameter larger than the outer diameter of the shaft portion 61A, and the flange portion 61C has an outer diameter larger than the outer diameter of the head portion 61B. Regarding the first eccentricity pin 61, the flange portion 61C is disposed to be interposed between the shaft portion 61A and the head portion 61B and the shaft portion 61A, the head portion 61B, and the flange portion 61C are integrally provided with each other.

The head portions 61B are formed to have an outer diameter matching the radial widths of the pressing target portions 42A and 42B of the first lens frame 25. The head portion 61B is provided with an insertion groove 61D into which a jig is inserted. An operator can insert the jig into the insertion groove 61D to rotate the first eccentricity pin 61.

The head portion 61B of the first eccentricity pin 61 is eccentric with respect to the shaft portion 61A. Accordingly, in a case where the first eccentricity pin 61 is rotated around the shaft portion 61A, the position of the head portion 61B is changed with respect to the shaft portion 61A. Note that the flange portion 61C is not eccentric with respect to the shaft portion 61A and is positioned to be coaxial with the shaft portion 61A.

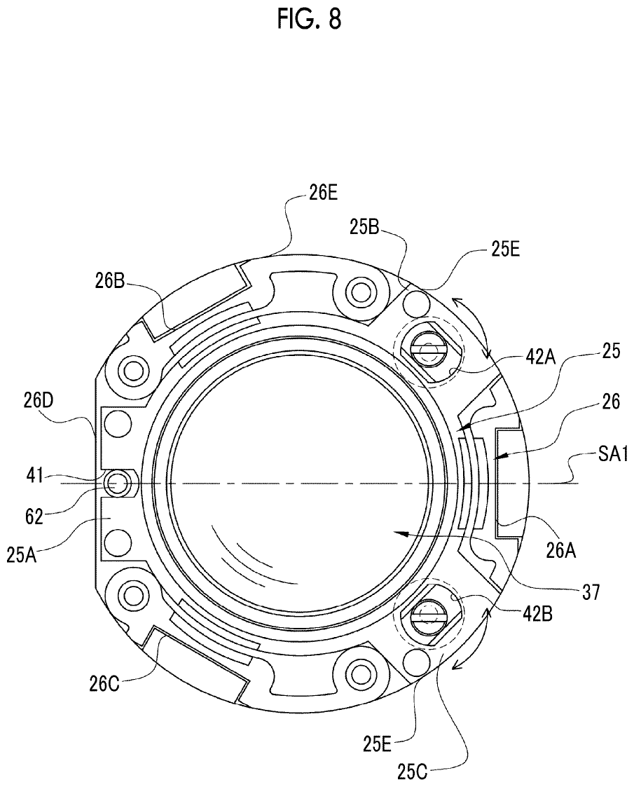

As shown in FIGS. 4 and 8, in the case of first adjustment performed by means of the first adjustment mechanisms 31, first, the positioning portion 41 of the first lens frame 25 is fitted to the positioning pin 62 fixed to the positioning hole 47 of the second lens frame 26, the shaft portions 61A of the first eccentricity pins 61 are fitted to the fitting holes 49A and 49B of the second lens frame 26, and the head portions 61B of the first eccentricity pins 61 are fitted to the pressing target portions 42A and 42B of the first lens frame 25. Accordingly, the second chord portion 26D of the second lens frame 26 can be positionally aligned with the first chord portion 25D of the first lens frame 25. In addition, the positioning portion 41 can be positionally aligned with the positioning hole 47. As described above, the first adjustment is performed in a state where the first lens frame 25 and the second lens frame 26 are integrated with each other.

As described above, the pressing target portions 42A and 42B are at positions that are line-symmetrical with respect to the symmetry axis SA1 and the head portions 61B of the first eccentricity pins 61 constituting the first adjustment mechanisms 31 are fitted to the pressing target portions 42A and 42B. That is, two first adjustment mechanisms 31 are disposed and are at positions that are line-symmetrical with respect to the symmetry axis SA1.

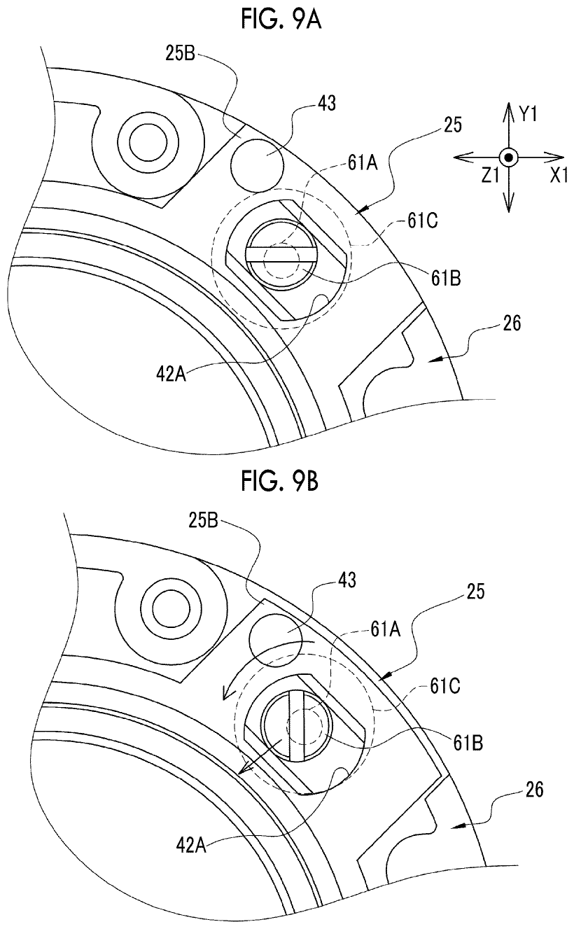

As shown in FIG. 9A, regarding the first adjustment mechanisms 31, the head portions 61B of the first eccentricity pins 61 are exposed through the pressing target portions 42A and 42B of the first lens frame 25. Accordingly, each of the first eccentricity pins 61 fitted to the fitting holes 49A and 49B of the second lens frame 26 can be rotated around a central axis of the shaft portion 61A. In addition, as shown in FIG. 9B, in a case where at least one of the first eccentricity pins 61 is rotated around the central axis of the shaft portion 61A, the pressing target portions 42A and 42B are pressed. With the pressing target portions 42A and 42B pressed, the first lens frame 25 can be moved (shifted) in the X1 direction and the Y1 direction with respect to the second lens frame 26. That is, the first lens frame 25 can be moved such that the position of the first optical axis OA1 of the first lens 37 coincides with the position of the second optical axis OA2 of the second lens 38. In this manner, the first adjustment of the first lens frame 25 with respect to the second lens frame 26 can be performed.

As shown in FIG. 10, the support member 34 includes a first support member 65 and a second support member 66. The first support member 65 and the second support member 66 are fastened to each other by being screwed by a plurality of screw members 67. In addition, the present disclosed technology is not limited thereto, and the support member 34 may be composed of one component. The first support member 65 supports the second lens frame 26. As a method of supporting the second lens frame 26 with respect to the first support member 65, any method such as a method of screwing the second lens frame 26, a method of fixing the second lens frame 26 by fitting the second lens frame 26, and a method of fixing the second lens frame 26 by sticking the second lens frame 26 with an adhesive may be used as long as the second lens frame 26 can be supported.

The first support member 65 includes contact portions 68A to 68C and a positioning groove 69. The contact portions 68A to 68C are provided at positions at which the contact portions 68A to 68C come into contact with the end surface portions 26A to 26C of the second lens frame 26, respectively. The contact portions 68A to 68C include regulation portions 71A to 71C, respectively. The regulation portions 71A to 71C are through-holes to which the second eccentricity pins 81, which will be described later, are fitted.

As shown in FIG. 10, the second adjustment mechanisms 32 include a plurality of the second eccentricity pins 81. In the present embodiment, the second adjustment mechanisms 32 include three second eccentricity pins 81 in accordance with the press-fitting holes 45A to 45C. As described above, the press-fitting holes 45B and 45C are at positions that are line-symmetrical with respect to the symmetry axis SA2, and the press-fitting hole 45A is at a position on the symmetry axis SA2. That is, three second adjustment mechanisms 32 are disposed, one of the second adjustment mechanisms 32 is at a position on the symmetry axis SA2, and the remaining two second adjustment mechanisms 32 are at positions that are line-symmetrical with respect to the symmetry axis SA2.

As shown in FIG. 11, the second eccentricity pin 81 includes a shaft portion 81A and a head portion 81B. The head portion 81B has an outer diameter larger than the outer diameter of the shaft portion 81A. Regarding the second eccentricity pin 81, the shaft portion 81A and the head portion 81B are integrally provided with each other. The shaft portions 81A of the second eccentricity pins 81 are press-fitted into a plurality of the press-fitting holes 45A to 45C, respectively. The shaft portions 81A may have any outer diameter as long as the shaft portions 81A can be press-fitted into the press-fitting holes 45A to 45C. For example, the shaft portions 81A may have any outer diameter as long as the outer diameter thereof is smaller than the outer diameter of circumscribed circles of the press-fitting holes 45A to 45C and larger than the outer diameter of inscribed circles of the press-fitting holes 45A to 45C. The head portion 81B is provided with an insertion groove 81C into which a jig is inserted. An operator can insert the jig into the insertion groove 81C to rotate the second eccentricity pin 81.

As with the first eccentricity pin 61, the head portion 81B of the second eccentricity pin 81 is eccentric with respect to the shaft portion 81A. Accordingly, in a case where the second eccentricity pin 81 is rotated around the shaft portion 81A, the position of the head portion 81B is changed with respect to the shaft portion 81A.

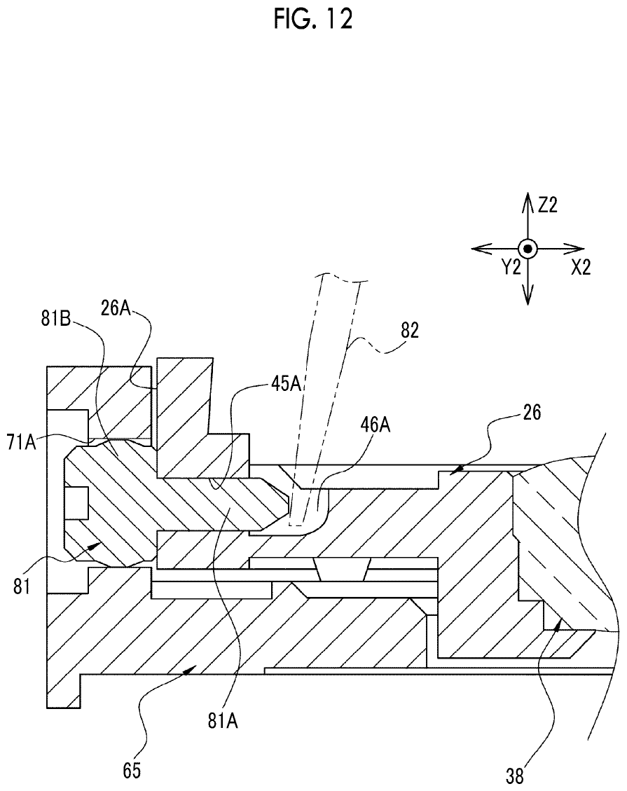

As shown in FIG. 12, in a state where the second eccentricity pin 81 is press-fitted into the press-fitting hole 45A, the shaft portion 81A is exposed at the recess portion 46A as seen in the Z2 direction. Similarly, in a state where the second eccentricity pins 81 are press-fitted into the press-fitting holes 45B and 45C, the shaft portions 81A are exposed at the recess portions 46B and 46C as seen in the Z2 direction. Accordingly, it is possible to press the second eccentricity pins 81 by inserting a jig 82 or the like into the recess portions 46A to 46C. Note that in FIG. 12, the first lens frame 25, the second support member 66, and the like are not shown in order to prevent complication.

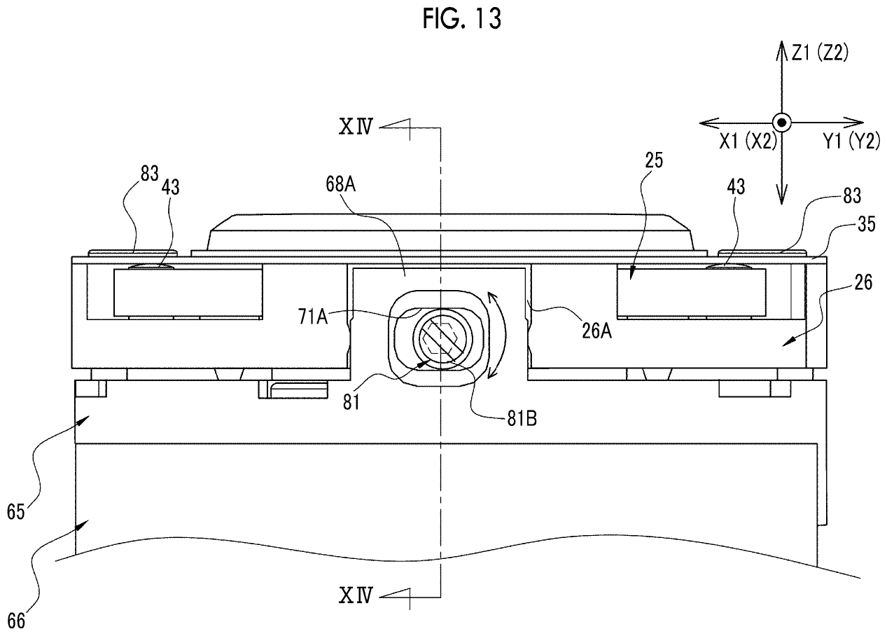

As shown in FIGS. 10 and 13, in the case of second adjustment performed by means of the second adjustment mechanisms 32, first, the first lens frame 25 and the second lens frame 26 are caused to enter a state where the first lens frame 25 and the second lens frame 26 are combined with each other (a state where the first lens frame 25 and the second lens frame 26 are integrated with each other in the first adjustment), the end surface portions 26A to 26C are brought into contact with the contact portions 68A to 68C, and a tip end portion of the positioning pin 62 is positionally aligned with the positioning groove 69. Accordingly, the first chord portion 25D of the first lens frame 25 and the second chord portion 26D of the second lens frame 26 can be positionally aligned with the positioning groove 69.

As shown in FIG. 11, the shaft portion 81A of the second eccentricity pin 81 constituting the second adjustment mechanisms 32 is press-fitted into the press-fitting hole 45B, and the head portion 81B of the second eccentricity pin 81 is fitted to the regulation portion 71B of the first support member 65. Note that although only a state where the shaft portion 81A is press-fitted into the press-fitting hole 45B and the head portion 81B is fitted to the regulation portion 71B is shown in FIG. 11, the shaft portions 81A are press-fitted into the press-fitting holes 45A and 45C as well and the head portions 81B are fitted into the regulation portions 71A and 71C as well. Accordingly, the regulation portions 71A to 71C regulate the positions of the head portions 81B in the Z2 direction.

As shown in FIG. 13, regarding the second adjustment mechanisms 32, it is possible to perform the second adjustment of the first lens frame 25 and the second lens frame 26 by rotating the second eccentricity pins 81 press-fitted into the press-fitting holes 45A to 45C of the second lens frame 26 around the central axes of the head portions 81B. That is, in a case where the second eccentricity pins 81 are rotated around the central axes of the head portions 81B, the head portions 81B do not move since the regulation portions 71A to 71C regulate the positions of the head portions 81B in the Z2 direction. However, since the head portions 81B are eccentric with respect to the shaft portions 81A as described above, the positions of the shaft portions 81A can be displaced with respect to the head portions 81B in the Z2 direction. In addition, in this case, the regulation member 35 is not fixed to the second lens frame 26, and screw members 83 fastening the regulation member 35, which will be described later, are loosened.

As shown in FIG. 14, in a case where one of the second eccentricity pins 81 is rotated around the central axis of the head portion 81B, the position of the shaft portion 81A is changed with respect to the head portion 81B in the Z2 direction. Accordingly, the press-fitting hole 45A into which the shaft portion 81A is press-fitted is also moved in the Z2 direction at the same time. Note that although the second eccentricity pin 81 of which the shaft portion 81A is press-fitted into the press-fitting hole 45A is shown in FIGS. 14 and 15, the same applies to the second eccentricity pins 81 press-fitted into the press-fitting holes 45B and 45C.

In a case where only one second eccentricity pin 81 is rotated and the remaining two second eccentricity pins 81 are not rotated, only the press-fitting hole 45A into which the rotated second eccentricity pin 81 is press-fitted is moved in the Z2 direction and thus the press-fitting holes 45B and 45C into which the remaining two second eccentricity pins 81 are press-fitted are not moved. That is, since only one press-fitting hole 45A is moved in the Z2 direction, the first lens frame 25 and the second lens frame 26 are rotated (a state shown in FIG. 15). That is, the second adjustment can be performed for inclination of the first optical axis OA1 of the first lens 37 and the second optical axis OA2 of the second lens 38.

As described above, the operator checks the image formation performance of the imaging lens 36 after performing the first adjustment and the second adjustment, and checks whether or not optical axis eccentricity is appropriately corrected. A method of checking the image formation performance of the imaging lens 36 is the same as that in the related art, and the image formation performance is checked by, for example, visually checking an image obtained by imaging a test chart through the imaging lens 36. After the image formation performance is checked, the first lens frame 25 and the second lens frame 26 are fixed to the support member 33 through screwing or the like.

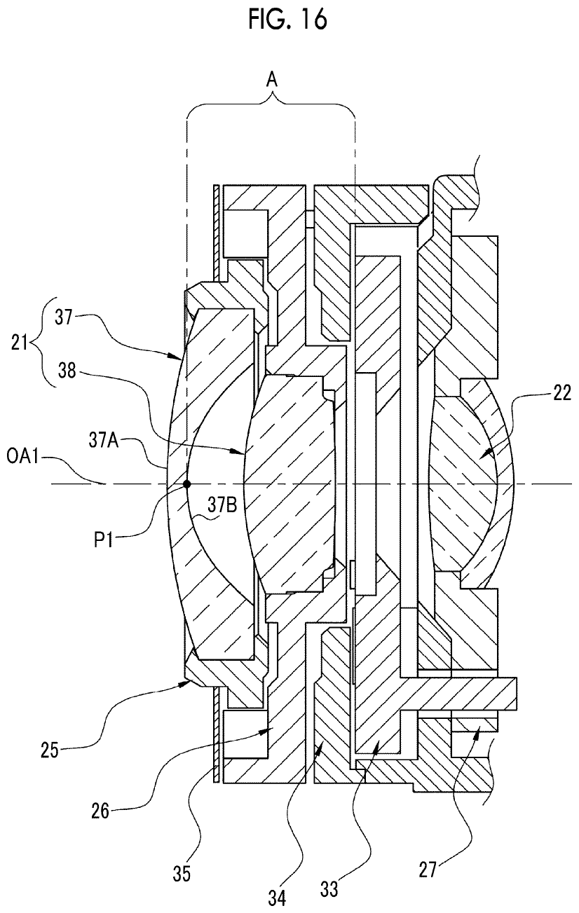

As shown in FIG. 16, the first adjustment mechanism 31 and the second adjustment mechanism 32 described above are disposed in an area A that is closer to the image plane side than a first position P1 is and is closer to the objective side than the stop mechanism 33 is, the first position P1 being a position at which a second surface 37B of the first lens 37 and the first optical axis OA1 of the first lens 37 intersect each other. Note that a first surface 37A of the first lens 37 is a surface on the objective side, and the second surface 37B is a surface on the image plane side.

The regulation member 35 is an annular member that regulates the position of the first lens frame 25 in the Z1 direction. Specifically, the second lens frame 26 is fastened by being screwed with a plurality of the screw members 83 (refer to FIG. 13). The regulation member 35 is fastened to the second lens frame 26 to be brought into contact with the projection portions 43 of the first lens frame 25. The position of the first lens frame 25 in the Z1 direction is regulated since the first lens frame 25 is pressed by the regulation member 35 that is in contact with the projection portions 43.

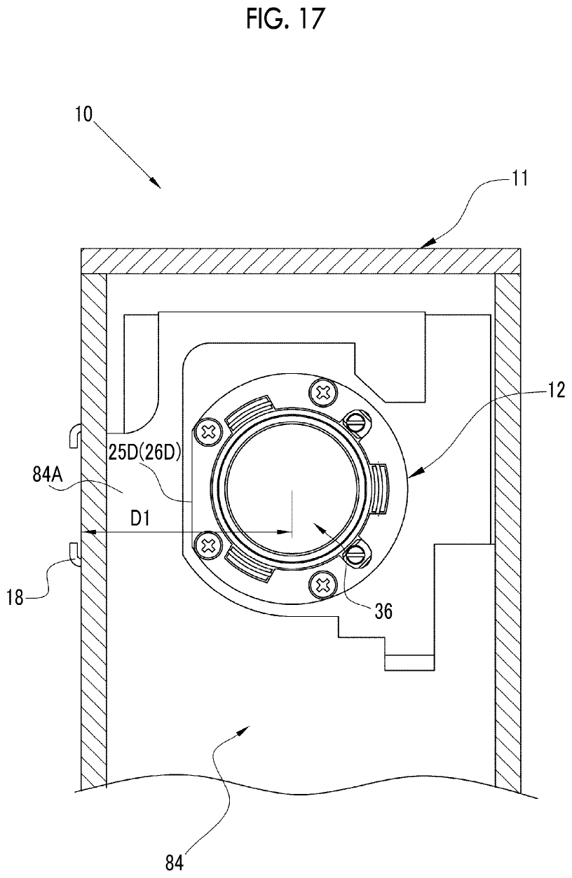

As shown in FIG. 17, a circuit board 84 is provided inside the camera body 11. The circuit board 84 is provided with a controller and the like that control each unit of the digital camera 10. The circuit board 84 is connected to the hot shoe 18. It is known that the hot shoe 18 is provided at a position as close as possible to the lens device 12 since a flash device or the like is attached thereto. That is, an interval D1 between the lens axis of the lens device 12 and the hot shoe 18 needs to be small. As described above, in the present embodiment, the camera body 11 has a vertically long box-like shape, and the hot shoe 18 is provided on one side surface of the camera body 11 so that the hot shoe 18 is brought close to the lens device 12.

However, in the case of a lens device in the related art, the outer shape of the lens device is a columnar shape and thus a space for connection between a hot shoe and a circuit board cannot be secured in a case where the lens axis of the lens device and the hot shoe are brought too close to each other. On the other hand, in the case of the lens device 12 according to the embodiment of the present invention, since the first lens frame 25 is provided with the first chord portion 25D and the second lens frame 26 is provided with the second chord portion 26D, it is possible to enlarge a space between the hot shoe 18 and the lens device 12 by disposing the first chord portion 25D and the second chord portion 26D at positions facing the hot shoe 18. A portion 84A of the circuit board 84 can be disposed in the space between the hot shoe 18 and the lens device 12. As described above, the interval D1 between the lens axis of the lens device 12 and the hot shoe 18 can be made small, and a space for connection between the hot shoe 18 and the circuit board 84 can be secured. That is, it is possible to reduce the sizes and weights of the lens device 12 and an imaging apparatus including the lens device 12.

As described above, in the case of the lens device 12 according to the embodiment of the present invention, it is possible to easily perform, by using the first adjustment mechanisms 31 and the second adjustment mechanisms 32, adjustment of the optical axes of the first lens 37 and the second lens 38, that is, adjustment of the positions and the degrees of inclination of the first optical axis OA1 of the first lens 37 and the second optical axis OA2 of the second lens 38, and it is possible to reduce the size and the weight of the entire device.

In addition, since the positions of the four projection portions 43 of the first lens frame 25 are regulated by the regulation member 35, a state where the accuracy of the positions and the degrees of inclination of the first optical axis OA1 of the first lens 37 and the second optical axis OA2 of the second lens 38 is favorable can be maintained after the first adjustment and the second adjustment are performed.

In addition, since the cross-sectional shape of each of the press-fitting holes 45A to 45C into which the second eccentricity pins 81 are press-fitted is a polygonal shape, the area of contact between the shaft portions 81A of the second eccentricity pins 81 and the press-fitting holes 45A to 45C is small, and thus a press-fitting step can be easily performed.

In addition, since the recess portions 46A to 46C connected to the press-fitting holes 45A to 45C are provided, it is possible to easily push out the second eccentricity pins 81 by inserting a jig or the like into the recess portions 46A to 46C and to perform a press-fitting step again in a case where the second adjustment is to be restarted or the like.

The hardware structure of a processing unit that executes various kinds of processing, such as the controller provided in the circuit board 84, is various processors as shown below. The various processors include a central processing unit (CPU) and a graphical processing unit (GPU), which are general-purpose processors that execute software (a program) to function as various processing units, a programmable logic device (PLD), which is a processor of which the circuit configuration can be changed after manufacture, such as a field programmable gate array (FPGA), a dedicated electric circuit, which is a processor having a circuit configuration specially designed to execute various kinds of processing, and the like.

One processing unit may be composed of one of these various processors or a combination of two or more processors of the same type or different types (for example, a combination of a plurality of FPGAs, a combination of a CPU and an FPGA, a combination of a CPU and a GPU, or the like). In addition, a plurality of processing units may be composed of one processor. As examples of a configuration in which a plurality of processing units are composed of one processor, firstly, there is a configuration in which one processor is composed of a combination of one or more CPUs and software and the processor functions as a plurality of processing units as represented by a computer such as a client, a server, or the like. Secondly, there is a configuration in which a processor that realizes the functions of the entire system including a plurality of processing units with one integrated circuit (IC) chip is used as represented by a system-on-chip (SoC) or the like. As described above, various processing units are configured by using one or more of the above-described various processors as the hardware structure.

Furthermore, more specifically, the hardware structure of the various processors is an electric circuit (circuitry) in which circuit elements such as semiconductor elements are combined with each other.

In each of the above-described embodiments, the lens device 12 including no zoom lens has been described as an example. However, the present invention is not limited thereto and the imaging lens 36 may include a zoom lens. In addition, the present invention can be applied to an imaging apparatus, such as a smartphone or a video camera, in addition to the digital camera. In addition, in the above-described embodiments, a stop mechanism of which a stop opening is fixed or mechanically variable has been described as an example. However, the stop mechanism that the lens device according to the embodiment of the present invention is not limited thereto and a configuration in which a neutral-density (ND) filter is provided and a stop mechanism of which a stop opening is variable with a change in density of the ND filter is provided may also be adopted.

### EXPLANATION OF REFERENCES

10: digital camera
11: camera body
11A: hinge portion
12: lens device
13: lens barrel portion
14: mode dial
15: release switch
16: power switch
17: operation lever
18: hot shoe
19: display
20: imaging element
21 to 24: first to fourth lens groups
25 to 29: first to fifth lens frames
25A to 25C: protruding portion
25D: first chord portion
25E: outer peripheral surface
26A to 26C: end surface portion
26D: second chord portion
26E: outer peripheral surface
26F: objective-side surface
31: first adjustment mechanism
32: second adjustment mechanism
33: stop mechanism
33A: stop opening
34: support member
35: regulation member
36: imaging lens
37: first lens
37A: first surface
37B: second surface
38: second lens
39: holder
41: positioning portion
42A, 42B: pressing target portion
43: projection portion
45A to 45C: press-fitting hole
46A to 46C: recess portion
47: positioning hole
48A, 48B: rotary guide portion
49A, 49B: fitting hole
61: first eccentricity pin
61A: shaft portion
61B: head portion
61C: flange portion
61D: insertion groove
62: positioning pin
65: first support member
66: second support member
67: screw member
68A to 68C: contact portion
69: positioning groove
71A to 71C: regulation portion
81: second eccentricity pin
81A: shaft portion
81B: head portion
81C: insertion groove
82: jig
83: screw member
84: circuit board
A: area
D1: interval
OA1: first optical axis
OA2: second optical axis
P1: first position
SA1: symmetry axis
SA2: symmetry axis

What is claimed is:

1. A lens device comprising:
a first lens frame that holds a first lens and that includes a first chord portion;
a second lens frame that holds a second lens positioned on an image plane side with respect to the first lens and that includes a second chord portion;
a first adjustment mechanism that performs first adjustment of the first lens frame;
a second adjustment mechanism that performs second adjustment of the first lens frame and the second lens frame; and
a stop mechanism that is positioned on the image plane side with respect to the second lens,
wherein the first lens includes a first surface positioned on an objective side and a second surface positioned on the image plane side,
the first adjustment mechanism and the second adjustment mechanism are disposed at positions that are closer to the image plane side than a first position is and closer to the objective side than the stop mechanism is, the first position being a position at which the second surface and a first optical axis of the first lens intersect each other, and
a position of the stop mechanism in an optical axis direction is fixed with respect to a first lens group including the first lens and the second lens.

2. The lens device according to claim 1,
wherein the second adjustment mechanism includes a second eccentricity pin of which a head portion is eccentric with respect to a shaft portion,
the second lens frame includes an end surface portion positioned radially outward of the second lens and a polygonal press-fitting hole formed in the end surface portion, and
the shaft portion of the second eccentricity pin is press-fitted into the press-fitting hole.

3. The lens device according to claim 2,
wherein the second lens frame includes a recess portion recessed in the optical axis direction, and
the press-fitting hole is connected to the recess portion.

4. The lens device according to claim 3,
wherein, in a state where the second eccentricity pin is press-fitted into the press-fitting hole, the shaft portion is exposed at the recess portion as seen in the optical axis direction.

5. The lens device according to claim 4, further comprising:
a support member that supports the second lens frame,
wherein the support member includes a regulation portion that regulates a position of the head portion in the optical axis direction, and
the second adjustment mechanism performs the second adjustment with the second eccentricity pin, of which the shaft portion is press-fitted into the press-fitting hole and of which the head portion is positionally regulated by the regulation portion, rotated around a central axis of the head portion so that a position of the shaft portion is displaced in the optical axis direction.

6. The lens device according to claim 5,
wherein the second lens frame includes a plurality of the press-fitting holes,
the second eccentricity pin is press-fitted into each of the plurality of press-fitting holes, and
the second adjustment with respect to degrees of inclination of the first optical axis of the first lens and a second optical axis of the second lens is performed with at least one second eccentricity pin rotated around the central axis so that the position of the shaft portion of the second eccentricity pin is displaced.

7. The lens device according to claim 6, further comprising:
a regulation member that regulates a position of the first lens frame in the optical axis direction,
wherein the first lens frame includes
a positioning portion that is disposed at the first chord portion, and
four projection portions that protrude in the optical axis direction and come into contact with the regulation member,
the four projection portions are at positions that are line-symmetrical with respect to a symmetry axis passing through the positioning portion and the first optical axis as seen in the optical axis direction, and
two of the four projection portions are disposed along the first chord portion.

8. The lens device according to claim 7,
wherein three second adjustment mechanisms are disposed,
one of the second adjustment mechanisms is at a position on the symmetry axis, and
remaining two second adjustment mechanisms are at positions that are line-symmetrical with respect to the symmetry axis.

9. The lens device according to claim 8,
wherein two first adjustment mechanisms are disposed and are at positions that are line-symmetrical with respect to the symmetry axis.

10. The lens device according to claim 9,
wherein the first adjustment mechanism includes a first eccentricity pin of which a head portion is eccentric with respect to a shaft portion,
the second lens frame includes a fitting hole to which the shaft portion of the first eccentricity pin is fitted,
the first lens frame includes a pressing target portion that is pressed by the first eccentricity pin, and
the first adjustment mechanism performs the first adjustment with the first eccentricity pin, which is fitted to the fitting hole, rotated around a central axis of the shaft portion so that the pressing target portion is pressed.

11. The lens device according to claim 10,
wherein the second lens frame includes a plurality of the fitting holes,
the first lens frame includes the pressing target portions corresponding to the fitting holes,
the first eccentricity pin is fitted to each of the plurality of fitting holes, and
the first adjustment in which the first lens frame is shifted in a direction intersecting the optical axis is performed with at least one first eccentricity pin rotated so that the pressing target portion is pressed.

12. The lens device according to claim 11,
wherein outer peripheral surfaces of the first lens frame and the second lens frame are partially arc-shaped, and the first chord portion and the second chord portion are surfaces that intersect the arc-shaped outer peripheral surfaces.
